(19) United States
(12) Patent Application Publication
(10) Pub. No.: US 2013/0124485 A1
(43) Pub. Date: May 16, 2013

(54) ELECTRONIC DEVICE, STORAGE MEDIUM, AND METHOD FOR DETECTING COMPATIBILITY OF FILES OF THE ELECTRONIC DEVICE

(71) Applicants: HSIAO-PING CHIU, Tu-Cheng (TW); CHUN-TANG HSU, Tu-Cheng (TW); SHU-PING CHEN, Tu-Cheng (TW); HSUEH-TSEN TSAI, Tu-Cheng (TW)

(72) Inventors: HSIAO-PING CHIU, Tu-Cheng (TW); CHUN-TANG HSU, Tu-Cheng (TW); SHU-PING CHEN, Tu-Cheng (TW); HSUEH-TSEN TSAI, Tu-Cheng (TW)

(73) Assignee: HON HAI PRECISION INDUSTRY CO., LTD., Tu-Cheng (TW)

(21) Appl. No.: 13/626,895

(22) Filed: Sep. 26, 2012

(30) Foreign Application Priority Data
Nov. 10, 2011 (TW) 100141127

(51) Int. Cl. G06F 17/30

(52) U.S. Cl. 707/690; 707/E17.01

(57) ABSTRACT

In a method for detecting compatibility of files of an electronic device, the method obtains a size and a format of an original file in response to moving the original file from an original storage area to a destination, and determines whether the original file and the destination are compatible with each other. If the original file and the destination are compatible with each other, the method receives the original file to the destination. If the original file and the destination are incompatible with each other, the method displays a prompt that the original file and the destination are incompatible on a display device of the electronic.

### BACKGROUND

1. Technical Field

The present disclosure relates to compatibility detecting systems and methods, and more particularly to an electronic device, a storage medium, and a method for detecting compatibility of files of the electronic device.

2. Description of Related Art

When files of an electronic device are moved to a destination, the electronic device does not detect compatibility between the files and the destination. Incompatibility of the files and the destination may lead to the electronic device crashing. Therefore, it may be inconvenient for users to move the files in the electronic devices.

### BRIEF DESCRIPTION OF THE DRAWINGS

FIG. 1 is a block diagram of one embodiment of an electronic device including a compatibility detecting system.

FIG. 2 is a flowchart of one embodiment of a method for detecting compatibility of files in the electronic device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word module, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

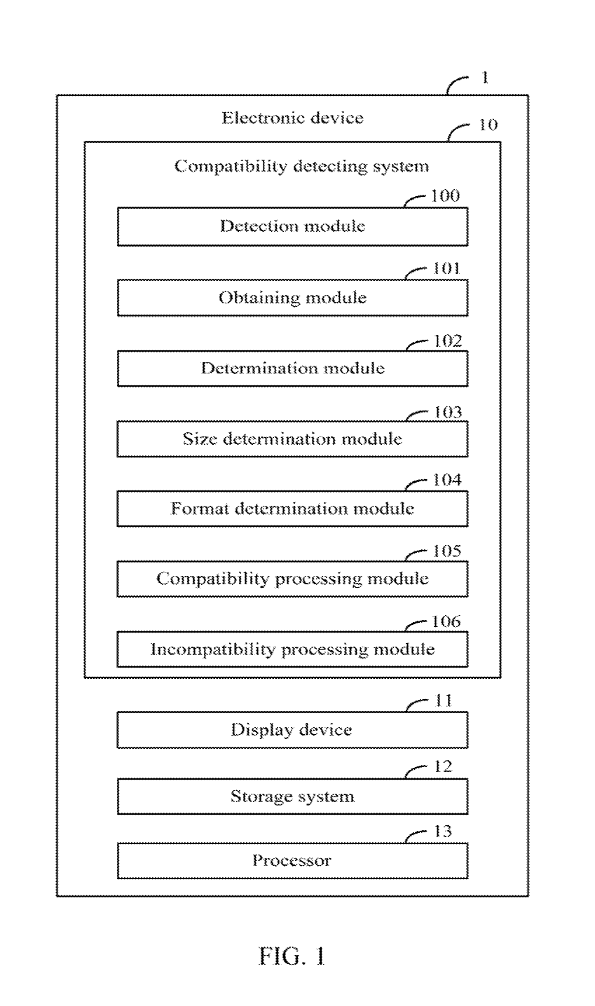

FIG. 1 is a block diagram of one embodiment of an electronic device 1 including a compatibility detecting system 10. In the embodiment, the electronic device 1 may be a mobile phone, a notebook computer, a personal digital assistant, or any other communication devices. The electronic device 1 further includes a display device 11, a storage system 12 and at least one processor 13. In one embodiment, the storage system 12 is divided (e.g., virtually or partitioned) into an original storage area and a destination storage area. The original storage area stores one or more original files of the electronic device 1, and the destination storage area stores one or more destination files of the electronic device 1. The original file or the destination file may be a text document, an application, or/and a folder, for example. The destination storage area and the destination files constitute a destination.

The compatibility detecting system 10 detects compatibility between an original file stored in the original storage area and the destination of the storage system 12, and process the original file and the destination according to a detected compatibility result. The compatibility result includes whether the original files are compatible with the destination or incompatible with the destination. The destination may be the destination storage area, or a destination file stored in the destination storage area. The compatibility result includes size compatibility, size incompatibility, format compatibility and format incompatibility.

In one embodiment, the original file includes information of size and format of the original file. The size is a data size of the original file, such as 5 KB or 100 MB, for example.

The format is a specification and style of the original file, such as MP4 or 3 GP, for example. If the size of the original file is less than a remaining size of the destination, the compatibility result of the original file and the destination is that they are compatible with each other in size (size compatibility). If the size of the original file is not less than the remaining size of the destination, the compatibility result of the original file and the destination is that they are incompatible with each other in size (size incompatibility). If the format of the original file is compatible with a format of the destination, the compatibility result of the original file and the destination is that they are compatible with each other in format (format compatibility). If the format of the original file is not compatible with the format of the destination, the compatibility result of the original file and the destination is that they are incompatible with each other in format (format incompatibility).

The display device 11 displays the compatibility result. The storage system 12 stores data of the electronic device 1. In one embodiment, the storage system 12 may be an internal storage device, such as a random access memory (RAM) for temporary storage of information, and/or a read only memory (ROM) for permanent storage of information. In some embodiments, the storage system 12 may also be an external storage device, such as an external hard disk, a storage card, or a data storage medium. The at least one processor 13 executes one or more computerized codes and other applications of the electronic device 1, to provide the functions of the compatibility detecting system 10.

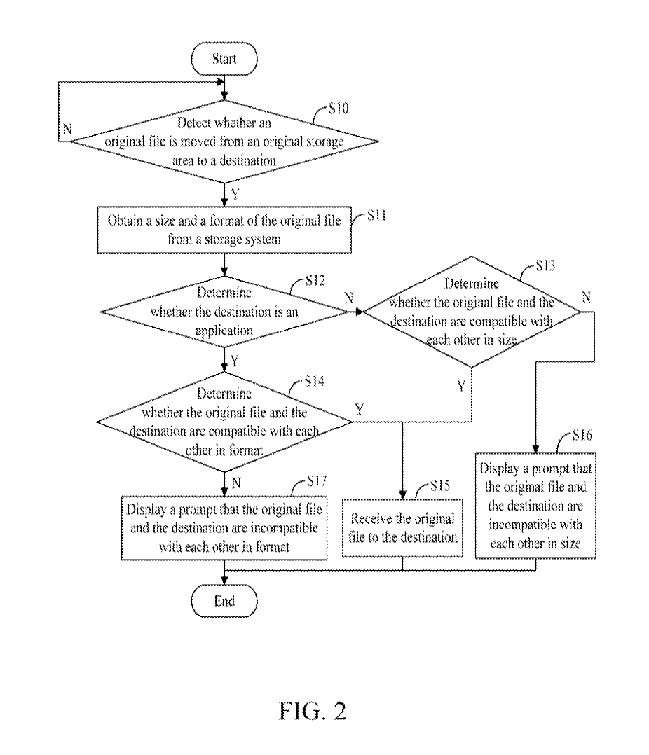

In one embodiment, the compatibility detecting system 10 may include a detection module 100, an obtaining module 101, a determination module 102, a size determination module 103, a format determination module 104, a compatibility processing module 105, and an incompatibility processing module 106. The modules 100-106 comprise computerized codes in the form of one or more programs that are stored in the storage system 12 of the electronic device 1. The computerized code includes instructions that are executed by the at least one processor 13 of the electronic device 1 to provide functions for the modules. Details of each of the modules are given in FIG. 2.

FIG. 2 is a flowchart of one embodiment of a method for detecting compatibility of files in the electronic device of FIG. 1. Depending on the embodiment, additional steps may be added, others deleted, and the ordering of the steps may be changed.

In step S10, the detection module 100 detects whether an original file is moved from an original storage area to a destination. If the original file is moved from the original storage area to the destination, step S11 is implemented. If the original file is not moved from the original storage area to the destination, step S10 is repeated. The destination may be the destination storage area, or a destination file stored in the destination storage area.

In one embodiment, the user may drag the original file from the original storage area to the destination, or copy the original file from the storage area and paste the original file to the destination, for example. The original file may be a text document, an application, a folder, for example.

In step S11, the obtaining module 101 obtains a size and a format of the original file from the storage system 12.

In step S12, the determination module 102 determines whether the destination is an application. If the destination is not the application, step S13 is implemented. If the destination is the application, step S14 is implemented.

In step S13, the size determination module 103 determines whether the original file and the destination are size compatibility. If the original file and the destination are size compatibility, step S15 is implemented. If the original file and the destination are size incompatibility, step S16 is implemented.

In one embodiment, the size determination module 103 determines whether the size of the original file is less than a remaining size of the destination. If the size of the original file is less than the remaining size of the destination, the size determination module 103 determines that the original file and the destination are size compatibility. If the size of the original file is not less than the remaining size of the destination, the size determination module 103 determines that the original file and the destination are size incompatibility.

For example, if the user drags a WORD file to a disk, the determination module 102 determines that the disk is not an application, and the size determination module 103 determines whether the size of the WORD file is less than the remaining size of the disk. If the size of the WORD file is less than the remaining size of the disk, the size determination module 103 determines that the WORD file and the disk are size compatibility. If the size of the WORD file is not less than the remaining size of the disk, the size determination module 103 determines that the WORD file and the disk are size incompatibility.

In step S14, the format determination module 104 determines whether the original file and the destination are format compatibility. If the original file and the destination are format compatibility, step S15 is implemented. If the original file and the destination are format incompatibility, step S17 is implemented.

In one embodiment, the format determination module 104 determines whether the format of the original file is compatible with the format of the destination. In one embodiment, the format of the destination can be updated through a network if the destination is the application. If the format of the original file is compatible with the format of the destination, the format determination module 104 determines that the original file and the destination are format compatibility. If the format of the original file is not compatible the format of the destination, the format determination module 104 determines that the original file and the destination are format incompatibility.

For example, if the user drags an audio file to a media player, the determination module 102 determines that the media player is an application, and the format determination module 104 determines whether the format of the audio file is compatible with the format of the media player. If the format of the audio file is compatible with the format of the media player, the format determination module 104 determines that the audio file and the media player are format compatibility. If the format of the audio file is not compatible with the format of the media player, the format determination module 104 determines that the audio file and the media player are format incompatibility.

In step S15, the compatibility processing module 105 receives the original file from the original storage area to the destination. In one embodiment, if the destination is the application, the compatibility processing module 105 receives the original file from the original storage area to the destination to execute subsequent operations, for example, the media player plays the audio file. If the destination is not the application, for example, a disk or a folder in the disk, the compatibility processing module 105 stores the original file into the destination.

In step S16, the incompatibility processing module 106 displays a prompt that the original file and the destination are size incompatibility on the display device 11. In one embodiment, the prompt corresponding to the size incompatibility prompts the user that the original file cannot be moved to the destination.

In step S17, the incompatibility processing module 106 displays a prompt that the original file and the destination are format incompatibility on the display device 11. In one embodiment, the prompt corresponding to the format incompatibility prompts the user that the format of the original file is not compatible with the format of the destination.

The electronic device 1 does not detect compatibility between the original file and the destination when the original file is moved from the original storage area to the destination. Incompatibility of the original file and the destination may lead to the electronic device 1 crashing. It is not convenient for the user to move the original file. However, with the present compatibility detecting system 10, the electronic device 1 detects compatibility between the original file and the destination when the original file is moved to the destination. If the original file and the destination are incompatibility, the original file cannot be moved to the destination of the electronic device 1. In this way, the electronic device 1 can avoid crashing because of the incompatibility of the original file.

The described embodiments are merely possible examples of implementations, and have been set forth for a clear understanding of the principles of the present disclosure. Many variations and modifications may be made without departing substantially from the spirit and principles of the present disclosure. All such modifications and variations are intended to be included herein within the scope of this disclosure and the described inventive embodiments, and the present disclosure is protected by the following claims.

What is claimed is:

1. A computer-implemented method of an electronic device, the method comprising:
(a) obtaining a size and a format of an original file from a storage system of the electronic device in response to moving the original file from an original storage area to a destination of the storage system;
(b) determining whether the original file and the destination are compatible with each other in size if the destination is not an application;
(c) determining whether the original file and the destination are compatible with each other in format if the destination is the application;
(d) receiving the original file from an original storage area of the storage system to the destination if the original file and the destination are compatible with each other in size or format; and
(e) displaying a prompt on a display device of the electronic device in response to if the original file and the destination are incompatible with each other in size or format, the prompt saying that the original file and the destination are incompatible with each other.

2. The method as claimed in claim 1, wherein the storage system is divided into the original storage area and a destination storage area, the original storage area stores one or more original files of the electronic device, and the destination storage area stores one or more destination files of the electronic device.

3. The method as claimed in claim 2, wherein the destination is the destination storage area or the destination file stored in the destination storage area.

4. The method as claimed in claim 1, wherein the step (b) comprises:
determining whether the size of the original file is less than a remaining size of the destination;
determining that the original file and the destination are compatible with each other in size if the size of the original file is less than the remaining size of the destination; and
determining that the original file and the destination are incompatible with each other in size if the size of the original file is not less than the remaining size of the destination.

5. The method as claimed in claim 1, wherein the step (c) comprises:
determining whether the format of the original file is compatible with a format of the destination;
determining that the original file and the destination are compatible with each other in format if the format of the original file is compatible with the format of the destination; and
determining that the original file and the destination are incompatible with each other in format if the format of the original file is not compatible with format of the destination.

6. The method as claimed in claim 1, wherein the step (d) comprises:
receiving the original file from the original storage area to the destination to execute subsequent operations of the original file if the destination is the application;
storing the original file into the destination if the destination is not the application.

7. A non-transitory computer readable storage medium storing a set of instructions, when executed by at least one processor of an electronic device, cause the at least one processor to perform a method of the electronic device, the method comprising:
(a) obtaining a size and a format of an original file from a storage system of the electronic device in response to moving the original file from an original storage area to a destination of the storage system;
(b) determining whether the original file and the destination are compatible with each other in size if the destination is not an application;
(c) determining whether the original file and the destination are compatible with each other in format if the destination is the application;
(d) receiving the original file from an original storage area of the storage system to the destination if the original file and the destination are compatible with each other in size or format; and
(e) displaying a prompt on a display device of the electronic device in response to if the original file and the destination are incompatible with each other in size or format, the prompt saying that the original file and the destination are incompatible with each other.

8. The storage medium as claimed in claim 7, wherein the storage system is divided into the original storage area and a destination storage area, the original storage area stores one or more original files of the electronic device, and the destination storage area stores one or more destination files of the electronic device.

9. The storage medium as claimed in claim 8, wherein the destination is the destination storage area or the destination file stored in the destination storage area.

10. The storage medium as claimed in claim 7, wherein the step (b) comprises:
determining whether the size of the original file is less than a remaining size of the destination;
determining that the original file and the destination are compatible with each other in size if the size of the original file is less than the remaining size of the destination; and
determining that the original file and the destination are incompatible with each other in size if the size of the original file is not less than the remaining size of the destination.

11. The storage medium as claimed in claim 7, wherein the step (c) comprises:
determining whether the format of the original file is compatible with a format of the destination;
determining that the original file and the destination are compatible with each other in format if the format of the original file is compatible with the format of the destination; and
determining that the original file and the destination are incompatible with each other in format if the format of the original file is not compatible with format of the destination.

12. The storage medium as claimed in claim 7, wherein the step (d) comprises:
receiving the original file from the original storage area to the destination to execute subsequent operations of the original file if the destination is the application;
storing the original file into the destination if the destination is not the application.

13. An electronic device, comprising:
a display device;
a storage system;
at least one processor; and
one or more programs that are stored in the storage system and executed by the at least one processor, the one or more programs comprising:
an obtaining module that obtains a size and a format of an original file from a storage system of the electronic device in response to moving the original file from an original storage area to a destination of the storage system;
a size determination module that determines whether the original file and the destination are compatible with each other in size if the destination is not an application;
a format determination module that determines whether the original file and the destination are compatible with each other in format if the destination is the application;
a compatibility processing module that receives the original file from an original storage area of the storage system to the destination if the original file and the destination are compatible with each other in size or format; and
an incompatibility processing module that displays a prompt on a display device of the electronic device in response to if the original file and the destination are incompatible with each other in size or format, the prompt saying that the original file and the destination are incompatible with each other.

14. The electronic device as claimed in claim 13, wherein the storage system is divided into the original storage area and a destination storage area, the original storage area stores one or more original files of the electronic device, and the destination storage area stores one or more destination files of the electronic device.

15. The electronic device as claimed in claim 14, wherein the destination is the destination storage area or the destination file stored in the destination storage area.

16. The electronic device as claimed in claim 13, wherein the size determination module:
determines whether the size of the original file is less than a remaining size of the destination;
determines that the original file and the destination are compatible with each other in size if the size of the original file is less than the remaining size of the destination; and
determines that the original file and the destination are incompatible with each other in size if the size of the original file is not less than the remaining size of the destination.

17. The electronic device as claimed in claim 13, wherein the format determination module:
determines whether the format of the original file is compatible with a format of the destination;
determines that the original file and the destination are compatible with each other in format if the format of the original file is compatible with the format of the destination; and
determines that the original file and the destination are incompatible with each other in format if the format of the original file is not compatible with format of the destination.

18. The electronic device as claimed in claim 13, wherein the compatibility processing module:
receives the original file from the original storage area to the destination to execute subsequent operations of the original file if the destination is the application;
stores the original file into the destination if the destination is not the application.
